(19) United States
(12) Patent Application Publication
(10) Pub. No.: US 2019/0086226 A1
(43) Pub. Date: Mar. 21, 2019

(54) TRAVEL PLAN GENERATION DEVICE, TRAVEL PLAN GENERATION METHOD, AND COMPUTER READABLE RECORDING MEDIUM

(71) Applicant: MITSUBISHI ELECTRIC CORPORATION, Tokyo (JP)

(72) Inventors: Yuji HAMADA, Tokyo (JP); Masahiko IKAWA, Tokyo (JP); Ryusuke KINOSHITA, Tokyo (JP)

(73) Assignee: MITSUBISHI ELECTRIC CORPORATION, Tokyo (JP)

(21) Appl. No.: 16/077,927

(22) PCT Filed: Mar. 30, 2016
(86) PCT No.: PCT/JP2016/060564

§ 371 Date: Aug. 14, 2018

(51) Int. Cl. G01C 21/36; G01C 21/20; G01C 21/34; G05D 1/02; G05D 1/00

(52) U.S. Cl. CPC G01C 21/3658; G01C 21/20; G05D 2201/0213; G05D 1/0212; G05D 1/0061; G01C 21/3453

(57) ABSTRACT

A cost storage unit stores costs corresponding to the travel state of a vehicle and road environment in which the vehicle travels. A plan management unit outputs route information indicating a route from a reference position to a destination. A plan generation unit generates a travel plan including a lane plan indicating lanes in which the vehicle travels in respective sections forming the route indicated by the route information output from the plan management unit based on the costs stored in the cost storage unit.

### TECHNICAL FIELD

The present invention relates to a technique for generating a travel plan to a destination.

### BACKGROUND ART

There is a car navigation system that guides a driver to a route to travel in road units by voice and display at proper timing by searching the route from a current location to a destination so that the driver of a vehicle arrives at the desired destination easily.

Research and development concerning an automatic driving system utilizing a sensor such as a camera and a millimeter-wave radar mounted on a vehicle, map information and so on are being conducted.

Currently, an autonomous emergency braking (AEB) for avoiding collision with a forward obstacle, an adaptive cruise control (ACC) for following a forward vehicle, an lane keeping system (LKS) for traveling while keeping a traveling lane and the like are commercialized.

Research and development concerning generation of a travel plan and realization of automatic driving based on the generated travel plan are being made for performing automatic driving to a destination designated by a driver on the assumption of the future automatic driving system.

Patent Literature 1 discloses search for a recommended route from a departure point to a destination by using a cost table which is set so that the more suitable for traveling by automatic driving control the route is, the lower a cost value is calculated.

### CITATION LIST

### Patent Literature

Patent Literature 1: JP2015-158467 A

### SUMMARY OF INVENTION

### Technical Problem

In Patent Literature 1, a route in which the automatic driving is hardly interrupted tends to be searched as the recommended route. However, costs are prescribed in road units in the cost table in Patent Literature 1. Accordingly, there is a case where it is difficult to produce an appropriate travel plan that matches the situation.

An object to the present invention is to produce an appropriate travel plan that matches the situation.

### Solution to Problem

A travel plan generation device according to the present invention includes:

a plan management unit to output route information indicating a route from a reference position to a destination; and

a plan generation unit to generate a travel plan including a lane plan indicating lanes in which a vehicle travels in respective sections forming the route indicated by the route information output from the plan management unit based on costs corresponding to a travel state of the vehicle and road environment in which the vehicle travels.

### Advantageous Effects of Invention

According to the present invention, a travel plan is generated based on costs corresponding to a traveling state of a vehicle and road environment in which the vehicle travels. Accordingly, an appropriate travel plan that matches the situation may be generated.

### BRIEF DESCRIPTION OF DRAWINGS

FIG. 1 is a configuration diagram of a travel plan generation device 10 according to Embodiment 1.

FIG. 2 is an explanatory view for information stored by a cost storage unit 131 according to Embodiment 1.

FIG. 3 is an explanatory view for information stored by a map data storage unit 132 according to Embodiment 1.

FIG. 4 is a flowchart of the entire operation of the travel plan generation device 10 according to Embodiment 1.

FIG. 5 is a flowchart of lane plan generation processing as processing for generating a lane plan according to Embodiment 1.

FIG. 6 is an explanatory view for section dividing processing in Step S23 according to Embodiment 1.

FIG. 7 is an explanatory view for sub-cost calculation processing in Step S26 according to Embodiment 1.

FIG. 8 is an explanatory view for a specific example of a lane plan according to Embodiment 1.

FIG. 9 is a chart illustrating a specific example of the lane plan according to Embodiment 1.

FIG. 10 is a flowchart of range setting processing according to Embodiment 1.

FIG. 11 is an explanatory view for start and end points setting processing in Step S34 according to Embodiment 1.

FIG. 12 is an explanatory view for prohibited section setting processing in Step S36 according to Embodiment 1.

FIG. 13 is an explanatory view for prohibited section setting processing in cases of right and left turns according to Embodiment 1.

FIG. 14 is a flowchart of mode plan generation processing according to Embodiment 1.

FIG. 15 is a chart illustrating a specific example of a mode plan according to Embodiment 1.

FIG. 16 is a configuration diagram of the travel plan generation device 10 according to Modification Example 1 and Modification Example 2.

FIG. 17 is a view illustrating another configuration of the travel plan generation device 10.

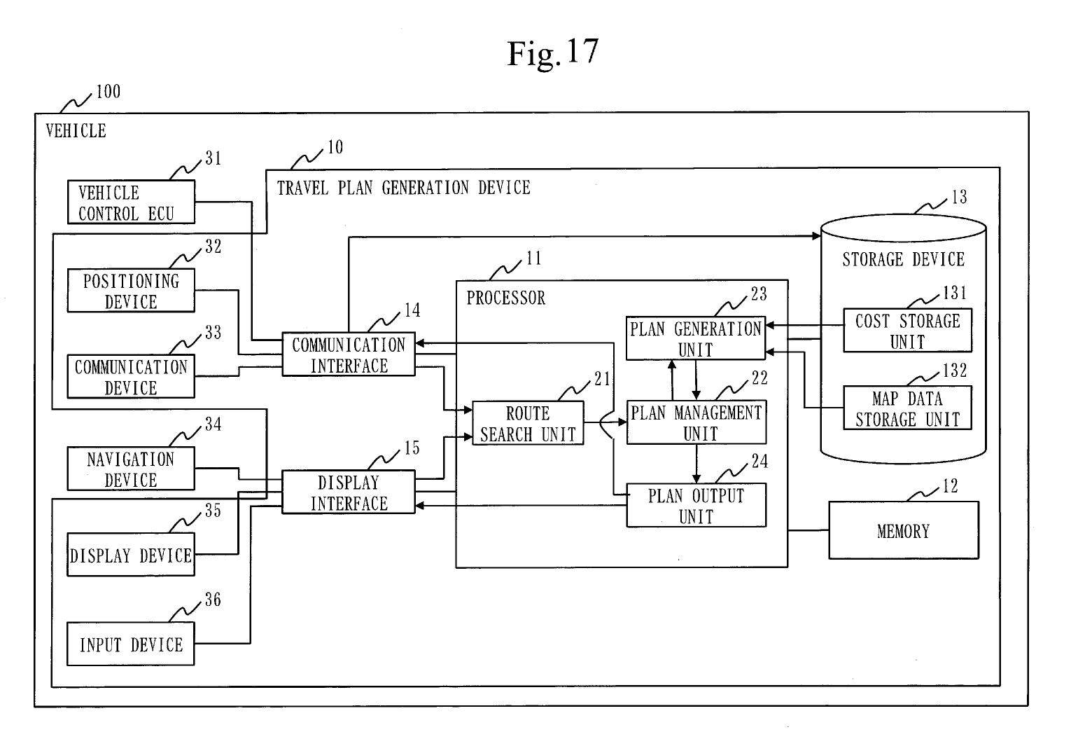

FIG. 18 is a configuration diagram of the travel plan generation device 10 according to Modification Example 4.

FIG. 19 is a configuration diagram of the travel plan generation device 10 according to Embodiment 2.

FIG. 20 is an explanatory view of start and end points setting processing in Step S34 according to Embodiment 2.

### DESCRIPTION OF EMBODIMENTS

### Embodiment 1

***Description of Structure***

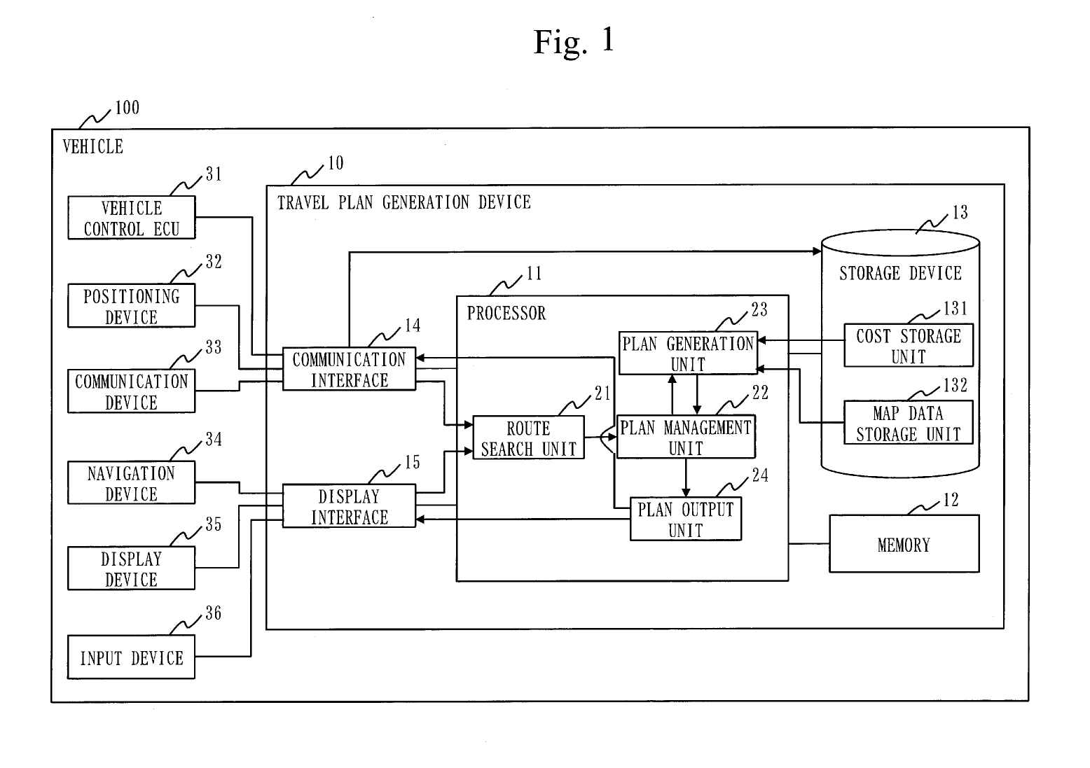

A configuration of a travel plan generation device 10 according to Embodiment 1 will be explained with reference to FIG. 1. FIG. 1 illustrates a state where the travel plan generation device 10 is mounted on a vehicle 100.

The travel plan generation device 10 may be mounted in an integrated state or in an inseparable state with respect to the vehicle 100 or shown other components as well as may be mounted in a removable state or in a separable state.

The travel plan generation device 10 is a computer to be mounted on the vehicle 100.

The travel plan generation device 10 includes hardware containing a processor 11, a memory 12, a storage device 13, a communication interface 14 and a display interface 15. The processor 11 is connected to other hardware through system buses, controlling these other hardware.

The processor 11 is an IC (Integrated Circuit) for executing instructions described in programs and performing processing such as transfer, calculation, process, control and management of data. The processor 11 includes a computing circuit, a register and a cache memory storing instructions and information. Specific examples of the processor 11 are a CPU (Central Processing Unit), a DSP (Digital Signal Processor) and a GPU (Graphics Processing Unit).

The memory 12 is a work space where data, information and programs are temporarily stored by the processor 11. A specific example of the memory 12 is a RAM (Random Access memory).

Specific examples of the storage device 13 are a flash memory and an HDD (Hard Disk Drive). The storage device 13 may also be a portable storage medium such as an SD (Secure Digital) memory card, a CF (Compact Flash), a NAND flash, a flexible disk, an optical disc, a compact disc, a blu-ray (trademark) disc and a DVD.

The communication interface 14 is a device for connecting a vehicle control ECU (Electronic Control Unit) 31, a positioning device 32, and a communication device 33 mounted on the vehicle 100. Specific examples of the communication interface 14 are terminals of Ethernet (trademark), CAN (Controller Area Network), RS232C, an USB (Universal Serial Bus) and IEEE1394.

The vehicle control ECU 31 is a device for acquiring vehicle information such as speed information detected by a speed sensor, acceleration information detected by an acceleration sensor, direction information detected by a direction sensor, steering angle information acquired by EPS (Electric Power Steering) and a brake control information acquired from a brake and for controlling control devices such as the brake, an accelerator and a steering wheel of the vehicle 100 to thereby control the behavior of the vehicle 100. Vehicle information may include other information such as travel history information, movement prediction information and a detection method of positional information. The vehicle control ECU 31 may acquire vehicle information periodically as well as by detecting occurrence of change in vehicle information.

The positioning device 32 is a device for measuring a position by using one or more of a positioning signal transmitted from a positioning satellite such as GPS (Global Positioning System), speed information detected by the speed sensor, acceleration information detected by the acceleration sensor, direction information detected by the direction sensor, steering angle information acquired by EPS and the like.

Part of information necessary for positional measurement and positioning data may be acquired by (1) the positioning device 32 and by (2) the travel plan generation device 10 via the communication interface 14 from the outside of the vehicle 100 through the communication device 33.

The communication device 33 is a device for performing wireless communication with devices such as a server provided outside the travel plan generation device 10 (or the vehicle 100), peripheral vehicles traveling around the vehicle 100, a roadside unit and a base station. Specific examples of the communication device 33 are an NIC (Network Interface Card), a DCM (Data Control Module) and a smart phone. The communication device 33 may use communication protocols such as DSRC (Dedicated Short Range Communication) and IEEE802.11p which are dedicated to vehicle communication, cell-phone networks such as LTE (Long Term Evolution) and 4G, wireless LAN such as Bluetooth (trademark) and IEEE802.11a/b/g/n, and may use infrared communication or visible light communication. The communication device 33 may also use any one of plural choices which are, for example, the cell-phone network and the wireless LAN, or may use both by being switched as well as at the same time.

The display interface 15 is a device for connecting devices such as a navigation device 34, a display device 35 and an input device 36 mounted on the vehicle 100. Specific examples of the display interface 15 are terminals of DVI (Digital Visual Interface), D-SUB (D-SUBminiature), and HDMI (trademark, High-Definition Multimedia Interface).

The navigation device 34 is a device for specifying a route from a position of the vehicle 100 positioned by the positioning device 32 to a destination input by a driver or the like and displaying route information indicating the specified route on the display device 35.

The display device 35 is a device for displaying route information and the like. A specified example of the display device 35 is an LCD (Liquid Crystal Display).

The input device 36 is a device for inputting information such as a destination by the driver or the like using characters or voice. Specified examples of the input device 36 are a touch panel, a microphone and a smart phone. The destination may be input as latitude and longitude or other information such as a facility name.

The travel plan generation device 10 includes a route search unit 21, a plan management unit 22, a plan generation unit 23, a plan output unit 24, a cost storage unit 131 and a map data storage unit 132 as functional components. Respective functions of the route search unit 21, the plan management unit 22, the plan generation unit 23 and the plan output unit 24 are realized by software. Respective functions of the cost storage unit 131 and the map data storage unit 132 are realized by the storage device 13.

The storage device 13 stores a program for realizing respective functions of the route search unit 21, the plan management unit 22, the plan generation unit 23 and the plan output unit 24. The program is read to the memory 12 by the processor 11 and executed by the processor 11.

Information, data, signal values and variable values indicating processing results of functions of respective units in the travel plan generation device 10 are stored in the memory 12, or, the register or the cache memory in the processor 11. In the following description, information, data, signal values and variable values indicating processing results of functions of respective units in the travel plan generation device 10 are assumed to be stored in the memory 12.

The program for realizing functions of respective units realized by software is assumed to be stored in the storage device 13. However, the program may also be stored in portable storage media such as a magnetic disc, a flexible disc, an optical disc, a compact disc, a blu-ray (trademark) disc and a DVD.

Only one processor 11 is shown in FIG. 1. However, plural processors 11 may be provided, and the plural processors 11 may execute the program for realizing respective functions in cooperation with one another.

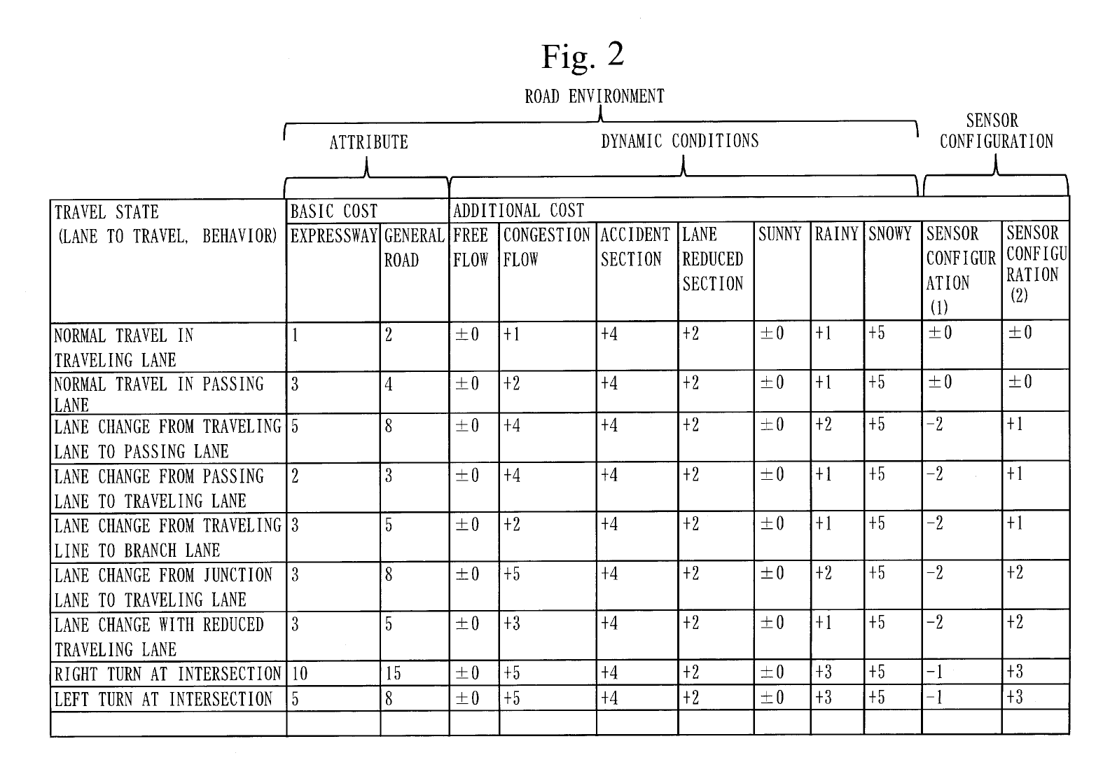

The cost storage unit 131 according to Embodiment 1 will be explained with reference to FIG. 2.

The cost storage unit 131 is a table storing costs of roads in accordance with conditions of a travel state of the vehicle 100 represented by respective rows of the table shown in FIG. 2, road environment in which the vehicle 100 travels and sensor configurations provided in the vehicle 100 represented by respective columns of the table shown in FIG. 2.

Conditions and costs stored in the cost storage unit 131 may be configured by information which is previously set, may be acquired through the communication device 33 and the communication interface 14 at some timing as well as may be dynamically set by learning during operation of the travel plan generation device 10.

A data structure or a display format of conditions and costs stored in the cost storage unit 131 may be prescribed by values directly indicating costs as shown in FIG. 2 as well as prescribed by using indirect values such as coefficients necessary for calculating the costs.

The travel state of the vehicle 100 indicates a lane in which the vehicle 100 travels and the behavior of the vehicle 100. The lane in which the vehicle 100 travels is a lane in which the vehicle 100 is traveling in a case where the road has plural lanes indicating whether the vehicle 100 travels in a traveling lane or in a passing lane. The behavior of the vehicle 100 includes operations of the vehicle 100 to change the lanes from the traveling lane to the passing lane, to change the lane from the passing lane to the traveling lane, to pass an intersection, to turn right at an intersection or to turn left at an intersection.

The road environment shows attributes of a road in which the vehicle 100 travels and dynamic conditions indicating a state of the road that changes dynamically.

The attributes of the road are static or quasi-static information including types of roads such as an expressway and a general road. The dynamic conditions include traffic conditions indicating whether a section is in a free flow in which traffic congestion does not occur, in a congestion flow in which traffic congestion occurs, in an accident section in which an accident happens or in a lane reduced section in which lanes are reduced due to regulations and the like, and weather conditions indicating sunny, rainy and snowy weather.

The sensor configuration is at least any of conditions of sensors provided in the vehicle 100 indicating whether the vehicle 100 has a sensor configuration (1) with high functions or a sensor configuration (2) with low functions and conditions of sensors and an infrastructure device of communication installed in the road. A specific example of the sensors and the infrastructure device of communication installed in the road is for detecting vehicles travelling on a main roadway at a merging point and distributing information to vehicles travelling on a merging lane. Another specific example is for distributing signal information at an intersection to vehicles traveling toward the intersection.

Each cost is a sum of a basic cost and an additional cost. The basic cost is a cost corresponding to the travel state of the vehicle 100 and the attribute of the road. The additional cost is a cost corresponding to the travel state of the vehicle 100, and dynamic conditions and the sensor configuration.

As a specific example, when the travel state of the vehicle 100 is normal travelling in the passing lane, the attribute of the road is the expressway, the dynamic conditions are the free flow and raining, and the sensor configuration is (2), the basic cost is 3 and the additional cost is 1 (=0+1+0), therefore, the cost will be 4.

Costs may be defined by other conditions in addition to the definition of costs shown in FIG. 2. It is also possible to calculate the final cost by giving coefficients to the basic cost and the additional cost respectively.

As specific examples, in a case of a road having three or more lanes on each side, costs may be defined by respective lanes, not being defined merely by the travelling lane and the passing lane as the travel state. Costs may also be defined with respect to conditions such as passing of a traffic signal or a temporary stop.

As the attributes of the road, costs may be defined separately with respect to a priority road in addition to the expressway and the general road. Also as the attributes of the road, costs may be defined in accordance with respective indexes such as the road shape and a regulation speed.

As the dynamic conditions, costs may be defined in accordance with the degree of congestion, not being defined merely as the congestion flow. As the weather conditions, costs may also be defined with respect to conditions such as cloudiness, heavy rain, fog, hail and thunder in addition to sunny, rainy and snowy weather. The costs may also be defined in accordance with luminance as well as defined in accordance with a time zone such as day or night. Costs may further be defined in accordance with conditions including the road shape such as a curve or a slope, the number of lanes and widths of lanes. Additionally, costs may be defined in accordance with accident information in the past such as accident prone spots.

As the sensor configuration, costs may be defined not only with respect to the sensor configuration (1) with high functions and the sensor configuration (2) with low functions but also with respect to indexes such as the number of sensors mounted on the vehicle 100, the detection distance and the detection direction.

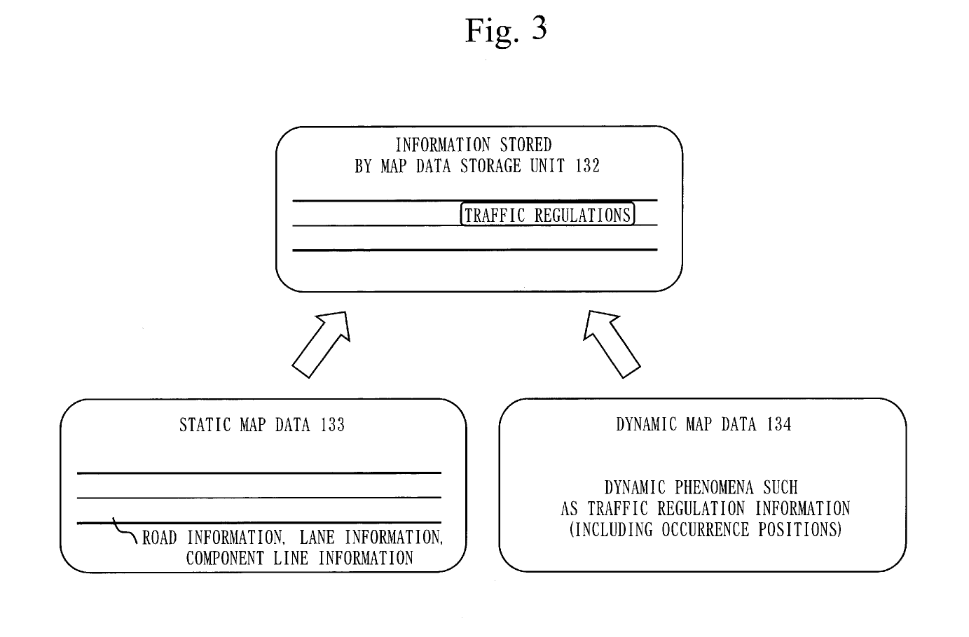

The map data storage unit 132 according to Embodiment 1 will be explained with reference to FIG. 3.

The map data storage unit 132 stores data in a state where static map data 133 indicating a static map is associated with a dynamic map data 134 indicating a place where a dynamic phenomenon occurs or stores a data structure having information for associating these data.

The static map data 133 is configured so that plural maps corresponding to predetermined scales are hierarchized. Respective maps include road information as information concerning roads, lane information as information concerning lanes included in roads and component line information as information concerning component lines included in lanes.

The road information contains the shape of a road, a latitude and a longitude of the road, a curvature of the road, a slope of the road, an identifier of the road, the number of lanes in the road, the type of the road and information concerning attributes in each road such as the general road, the expressway and the priority road. The lane information contains identifiers of lanes included in the road, latitudes and longitudes of lanes and information concerning a center line. The component line information contains identifiers of respective lines forming lanes, latitudes and longitudes of respective lines forming lanes and information concerning line types and curvatures of respective lines forming lanes. The road information is managed in road units. The lane information and the component line information are managed in lane units.

The static map data 133 is stored before the vehicle 100 starts to travel. The static map data 133 is updated by receiving update information through the communication device 33 and the communication interface 14 at intervals such as once in a year or once in half a year or in accordance with an operation of the input device 36 by a driver or the like. The static map data 133 may be updated by reading update information stored in a portable storage medium such as a DVD.

The dynamic map data 134 is dynamically changing information concerning traveling of the vehicle 100 such as traffic regulation information containing lane regulation, speed regulation, travel regulation and chain regulation, regulation information at places of gateways and tollgates, traffic congestion information, traffic accident information informing existence of a stopped vehicle and a low-speed vehicle, obstacle information informing existence of a falling object and an animal, road abnormality information informing a road damage and a road surface abnormality, peripheral vehicle information and weather information. The dynamic map data 134 contains positional information indicating occurrence positions.

The dynamic map data 134 is received through the communication device 33 and the communication interface 14 at intervals such as once in several minutes while the vehicle 100 travels, and is stored with the received time and an identifier of a transmission source. The dynamic map data 134 is deleted after a predetermined period of time passes from the reception. The dynamic map data 134 is also overwritten when the same information is updated.

The map data storage unit 132 stores the dynamic map data 134 and the static map data 133 so as to be associated with each other. As a specific example, road information/lane information is associated with the traffic regulation information in the map data storage unit 132. Accordingly, places where regulations such as the lane regulation occur can be specified on the static map.

In Embodiment 1, the associated static map data 133 is used at the same time when the dynamic map data 134 is used.

***Description of Operation***

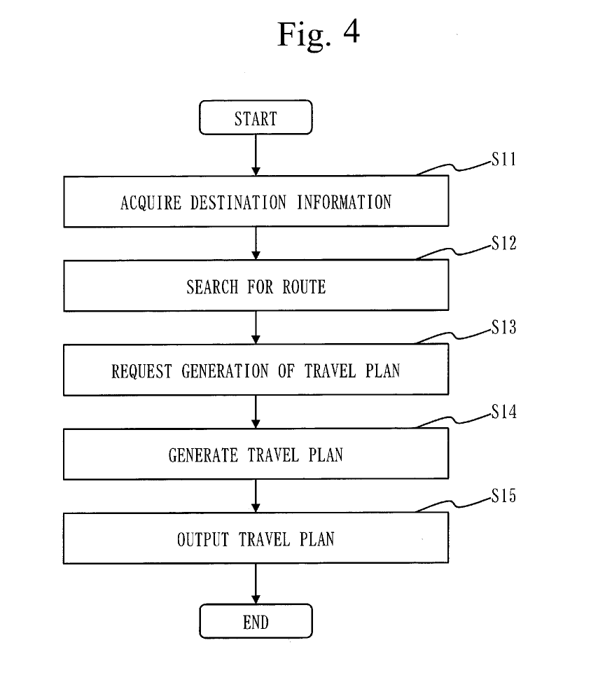

The operation of the travel plan generation device 10 according to Embodiment 1 will be explained with reference to FIG. 4 to FIG. 15.

The operation of the travel plan generation device 10 according to Embodiment 1 corresponds to a travel plan generation method according to Embodiment 1. The operation of the travel plan generation device 10 according to Embodiment 1 also corresponds to processing of a travel plan generation program according to Embodiment 1.

The entire operation of the travel plan generation device 10 according to Embodiment 1 will be explained with reference to FIG. 4.

(Step S11: Reception Processing)

The route search unit 21 acquires destination information indicating a destination input by the input device 36 through the display interface 15. The route search unit 21 may also acquire destination information from the navigation device 34.

(Step S12: Route Search Processing)

The route search unit 21 acquires positional information of the vehicle 100 measured and obtained by the positioning device 32 through the communication interface 14. Then, the route search unit 21 sets a position indicated by the positional information as a reference position and searches for a route from the reference position to the destination indicated by the destination information acquired in Step S11 to generate route information indicating the searched route.

As a method of searching for the route, existing methods such as Dijkstra's algorithm and A* search algorithm may be used. The route is searched for based on any of indexes such as time, distance, fuel consumption and comfort.

(Step S13: Plan Request Processing)

The plan management unit 22 acquires the destination information acquired in Step S11, the positional information acquired and the route information generated in Step S12 from the route search unit 21 by a method such as interprocess communication. The plan management unit 22 writes the acquired destination information, positional information and route information in the memory 12.

Then, the plan management unit 22 outputs the acquired destination information, positional information and route information to the plan generation unit 23 by a method such as interprocess communication and requests the plan generation unit 23 to generate a travel plan.

(Step S14: Plan Generation Processing)

The plan generation unit 23 acquires the destination information, positional information and route information output in Step S13. Then, the plan generation unit 23 generates a travel plan by using the acquired destination information, positional information and route information.

In Embodiment 1, the travel plan includes a lane plan indicating lanes in which the vehicle 100 travels in respective sections forming the route indicated by the route information and a mode plan indicating in which mode of automatic driving and manual driving the vehicle 100 is controlled in respective sections. The travel plan may include any one of the lane plan and the mode plan. The travel plan may include other plans such as a speed plan indicating travel speeds of the vehicle 100 in respective sections.

(Step S15: Plan Output Processing)

The plan generation unit 23 outputs the generated travel plan together with the time when the plan is generated to the plan management unit 22 by a method such as interprocess communication. The plan management unit 22 acquires the output travel plan and writes the acquired travel plan in the memory 12 so that the acquired travel plan is associated with the acquired destination information, positional information and route information acquired in Step S13.

Then, the plan management unit 22 outputs the acquired travel plan to the plan output unit 24 by a method such as interprocess communication. The plan output unit 24 acquires the output travel plan and outputs the acquired travel plan to the vehicle control ECU 31 through the communication interface 14 as well as to the display device 35 through the display interface 15.

The plan output unit 24 may output all the generated travel plan as well as may output only part of the generated travel plan in the vicinity of a position indicated by positional information. The plan output unit 24 may also output the travel plan only once when the travel plan is generated, may output the travel plan periodically as well as may output the travel plan every time the position of the vehicle 100 is updated.

The vehicle control ECU 31 acquires the output travel plan and controls the control devices such as the brake, the accelerator and the steering wheel of the vehicle 100 based on the acquired travel plan to control the behavior of the vehicle 100. As a specific example, the vehicle control ECU 31 controls the steering wheel and the like in accordance with the lane plan included in the travel plan and changes the lane in which the vehicle 100 travels.

The display device 35 acquires the output travel plan and displays the acquired travel plan. As a specific example, the display device 35 displays lanes in which the vehicle 100 travels in respective sections indicated by the lane plan and in which mode of the automatic driving and the manual driving the vehicle 100 is controlled in respective sections indicated by the mode plan.

In FIG. 4, the plan management unit 22 requests generation of the travel plan when destination information is acquired. The present invention is not limited to this and the plan management unit 22 may request generation of the travel plan when the vehicle 100 does not travel in accordance with the travel plan. As a specific example, the plan management unit 22 may request generation of the travel plan in a case where the vehicle 100 travels in a lane different from a lane indicated by the lane plan, a case where the vehicle 100 travels on a road deviated from a route indicated by the route information and some other cases. The plan management unit 22 may determine whether the vehicle 100 travels in accordance with the travel plan or not by the position or the like indicated by the positional information of the vehicle 100 obtained by being positioned by the positioning device 32.

In this case, the plan generation unit 23 may generate a travel plan for returning to a state in which the vehicle 100 can travel in accordance with the travel plan already generated without newly generating a travel plan to the destination.

The plan management unit 22 may also request generation of the travel plan in a case where the dynamic map data 134 is updated. As specific examples, the plan management unit 22 may request generation of the travel plan in a case where traffic congestion occurs, in a case where an accident happens in the route indicated by the route information and some other cases.

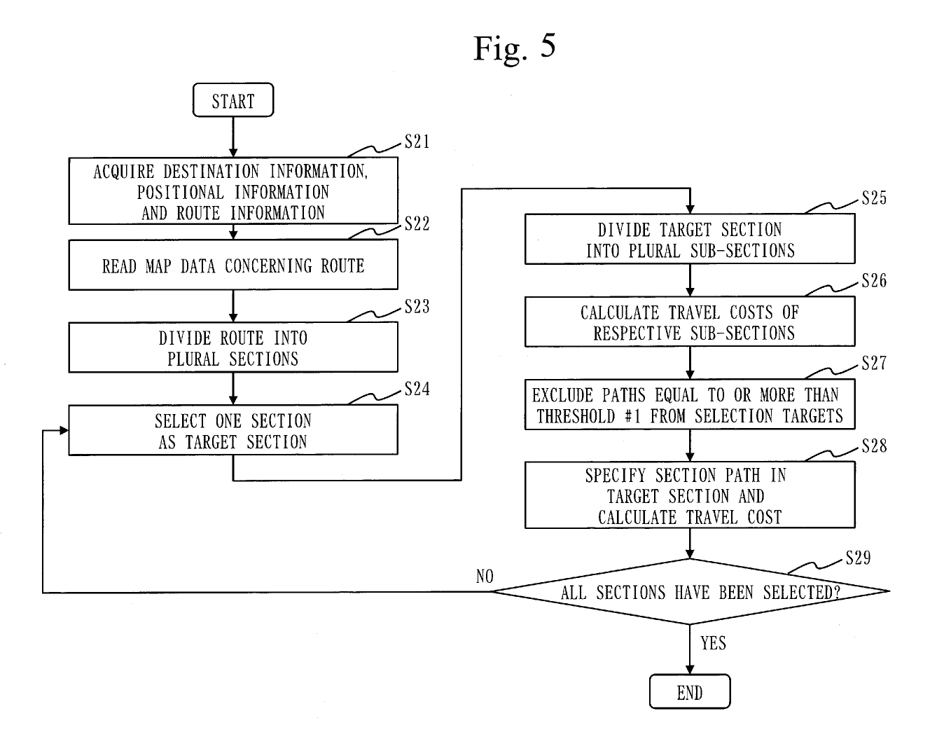

Lane plan generation processing as processing of generating the lane plan in the plan generation processing of Step S14 according to Embodiment 1 will be explained with reference to FIG. 5.

(Step S21: Acquisition Processing)

The plan generation unit 23 acquires the destination information, the positional information and the route information output in Step S13 by a method such as interprocess communication.

(Step S22: Map Acquisition processing)

The plan generation unit 23 reads the static map data 133 and the dynamic map data 134 concerning the route indicated by the route information acquired in Step S21 from the map data storage unit 132 of the storage device 13.

(Step S23: Section Dividing Processing)

The plan generation unit 23 divides the route indicated by the route information into plural sections based on the static map data 133 acquired in Step S22. In Embodiment 1, the plan generation unit 23 divides the route into plural sections by dividing the route at increasing/reducing points of lanes, merging points, branch points and intersections.

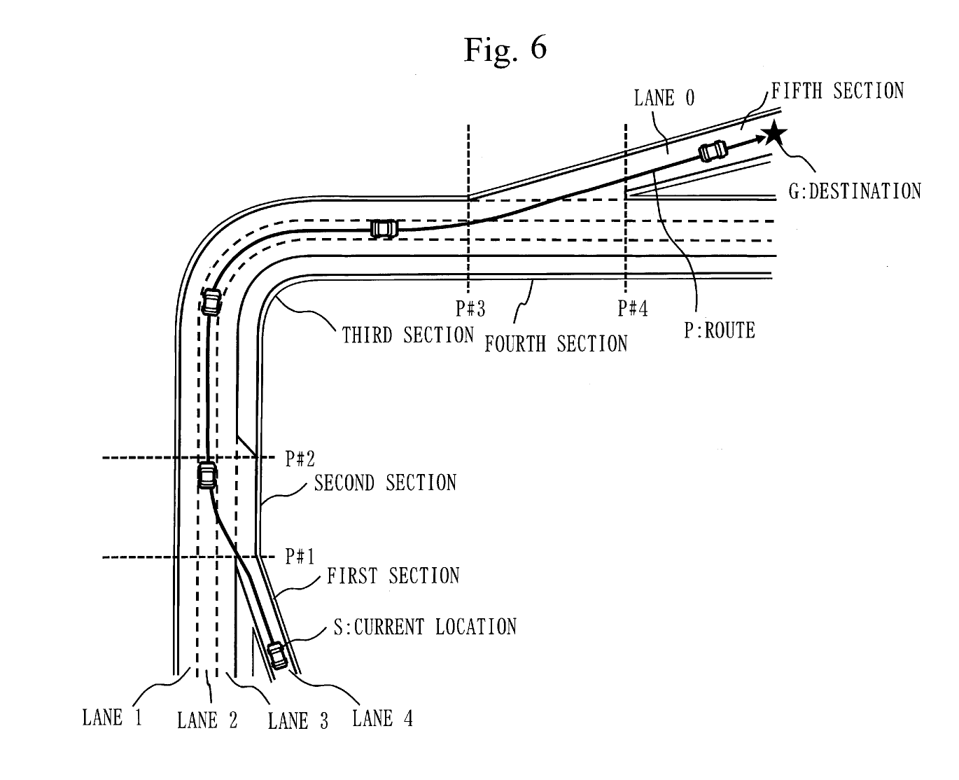

Specific explanation will be made with reference to FIG. 6. In FIG. 6, a route P from a current location S as a position indicated by positional information to a destination G indicated by destination information is divided at a point P#1, a point P#2, a point P#3 and a point P#4. The point P#1 is a position where merging occurs. The point P#2 is a position where the lanes are reduced. The point P#3 is a position where the lines are increased. The point P#4 is a position where branching occurs. Then, the route P is divided into a first section from the current location S to the point P#1, a second section from the point P#1 to the point P#2, a third section from the point P#2 to the point P#3, a fourth section from the point P#3 to the point P#4 and a fifth section from the point P#4 to the destination G.

(Step S24: Section Selection Processing)

The plan generation unit 23 selects one section from plural sections divided and generated in Step S23 as a target section. In Embodiment 1, the plan generation unit 23 selects one section sequentially from the section close to the position indicated by positional information as a target section.

(Step S25: Sub-Section Dividing Processing)

The plan generation unit 23 divides the target section selected in Step S24 into plural sub-sections by dividing the target section in front of and behind the target range of the dynamic map data 134. When there is not the dynamic map data 134 in the target section or when the entire target section corresponds to the target range of the entire dynamic map data 134 concerning the section, the target section will have one sub-section.

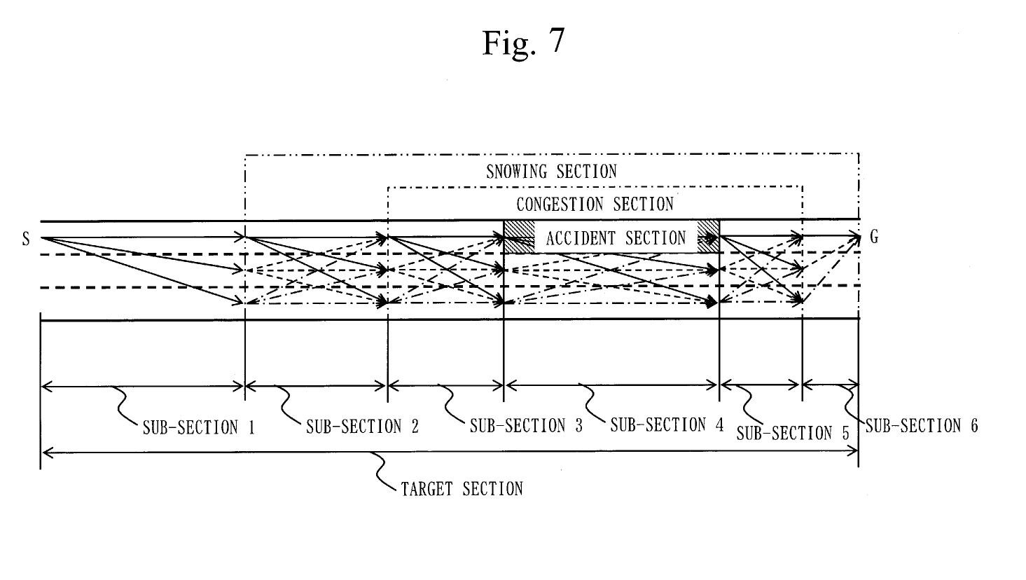

Specific explanation will be made with reference to FIG. 7. In FIG. 7, there are three dynamic map data 134 including a snowing section, a congestion section and an accident section in the target section, and the target section is divided in front of and behind each dynamic map data 134. As a position after the snowing section is an end point of the target section in FIG. 7, the point is excluded from the divided points.

Accordingly, the target section is divided at 5 points and the target section is divided into six sections of a sub-section 1 to a sub-section 6.

(Step S26: Sub-Cost Calculation Processing)

The plan generation unit 23 calculates travel costs of all sub-paths connecting start points to end points of respective sub-sections divided and generated in Step S25.

Specific explanation will be explained with reference to FIG. 7. In FIG. 7, travel costs of all sub-paths in which the vehicle can travel in six sub-sections of the sub-section 1 to the sub-section 6 as shown by arrows are calculated.

In FIG. 7, a case where a traveling lane of the start point in the target section is a lane 1 and a traveling lane of the end point in the target section is the lane 1 is shown. The traveling lane of the start point in the target section is a traveling lane of the end point of a previous section when there is the previous section, and is a lane at a position indicated by positional information when there is not the previous section. The traveling lane of the end point in the target section is a lane determined in accordance with the route. As specific examples, the traveling lane of the end point in the target section is a branch lane when the target section includes the branch, and the traveling lane of the end point in the target section is a left lane when the vehicle turns left in the subsequent section.

(Step S27: Sub-Path Exclusion Processing)

The plan generation unit 23 specifies sub-paths the travel costs of which calculated in Step S26 are equal to or more than a threshold #1. The plan generation unit 23 excludes the specified sub-paths from the selection targets. The threshold #1 is assumed to be stored in the memory 12 before starting the processing shown in FIG. 4. The threshold #1 is determined by the sensor configuration and so on mounted on the vehicle 100.

(Step S28: Path Specification Processing)

The plan generation unit 23 specifies a section path the travel cost of which becomes the lowest in section paths connecting from the start point of the target section to the end point of the target section. The plan generation unit 23 calculates the travel cost of the specified section path. The section path includes sub-paths selected from respective sub-sections forming the target section, and the travel cost is the sum of travel costs of respective sub-paths.

In this case, the plan generation unit 23 specifies a section path not containing sub-paths excluded from selection targets in Step S27. Accordingly, even when the travel cost as the entire section path is increased, the section path in which the travel cost in one sub-section is not equal to or more than the threshold #1 is selected. That is, the section path not containing a sub-section where driving is difficult is selected even when the travel cost as the entire section path is increased.

(Step S29: End Determination Processing)

The plan generation unit 23 determines whether all sections have been selected in Step S24 or not. That is, the plan generation unit 23 determines whether the section paths for all sections from the current location to the destination have been specified or not.

The plan generation unit 23 generates a lane plan indicating the section paths specified for respective sections in Step S28 and ends the lane plan generation processing in the case where all sections have been selected. The process returns to Step S24 when an unselected section remains.

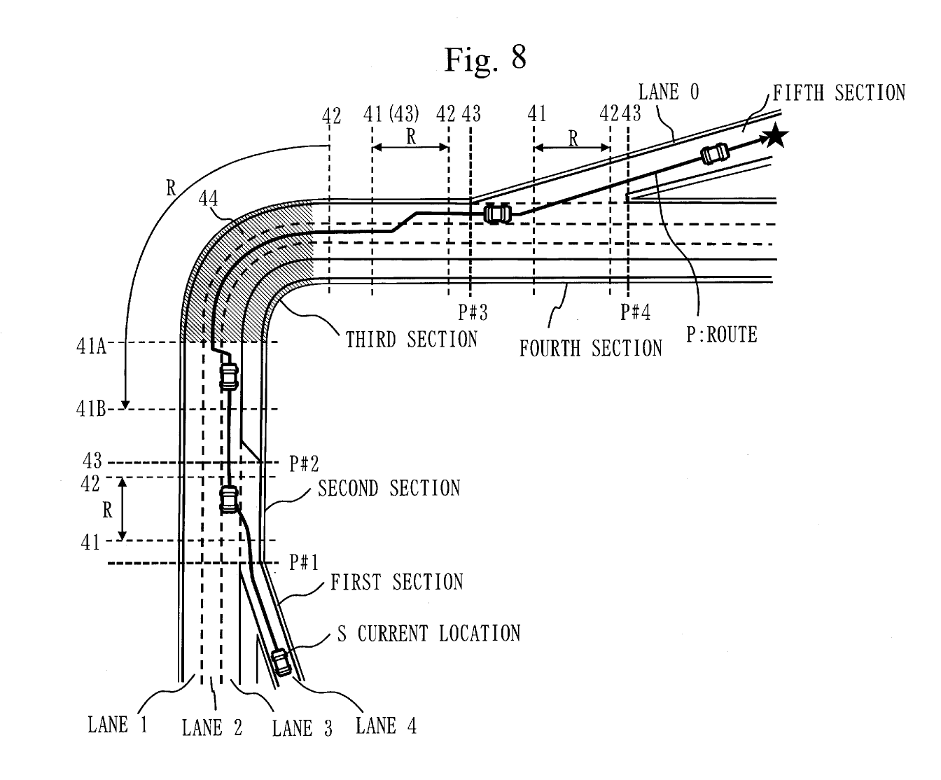

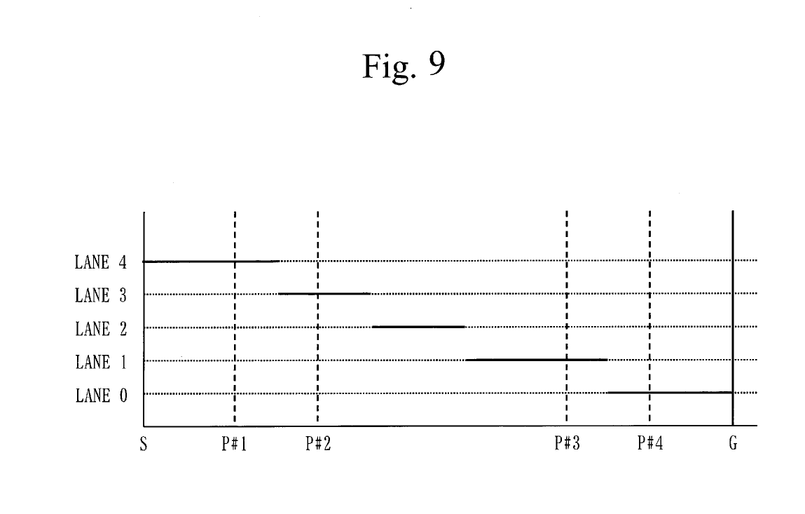

A specific example of the lane plan will be explained with reference to FIG. 8 and FIG. 9.

In FIG. 8, a road corresponding to FIG. 6 is shown. In FIG. 8 and FIG. 9, the vehicle 100 travels in a lane 4 as a merging lane from the current location S to the point P#1, changing the lane from the lane 4 to a lane 3 between the point P#1 and the point P#2, changing the lane from the lane 3 to a lane 1 between the point P#2 and the point P#3, changing the lane from the lane 1 to a lane “0” as the branch lane between the point P#3 and the point P#4 and traveling in the lane “0” from the point P#4 to the destination as the travel plan.

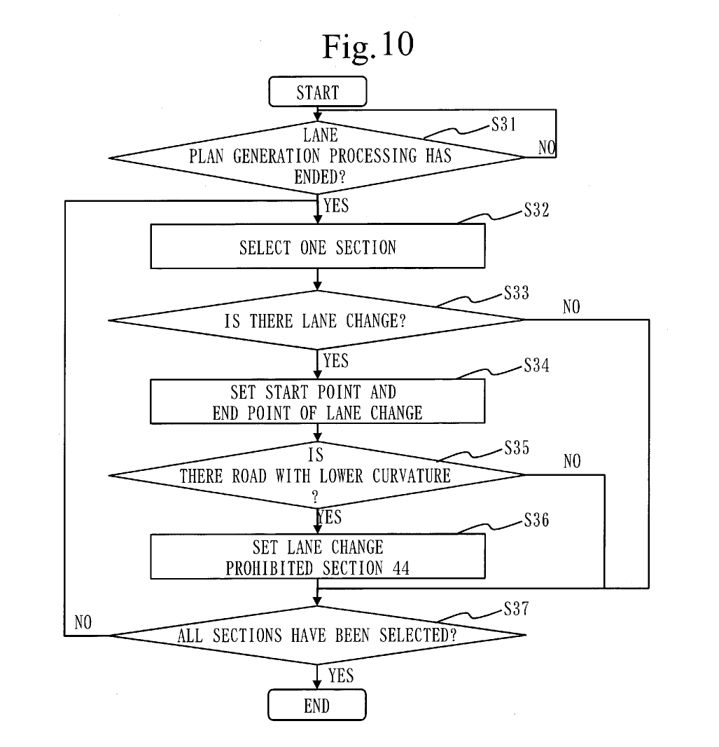

Range setting processing for setting a range R of a lane change as post-processing of the lane plan generation processing according to Embodiment 1 will be explained with reference to FIG. 10.

(Step S31: Start Determination Processing)

The plan generation unit 23 determines whether the lane plan generation processing has ended or not.

The plan generation unit 23 causes the processing to proceed to Step S32 in the case where the lane plan generation processing has ended, and executes Step S31 again after a certain period of time passes in the case where the lane plan generation processing has not ended.

(Step S32: Section Selection Processing)

The plan generation unit 23 selects one section from plural sections divided and generated in Step S23 as a target section.

(Step S33: Response Determination Processing)

The plan generation unit 23 determines whether the lane change occurs in the target section selected in Step S32 or not by referring to the lane plan generated in the lane plan generation processing and the static map data 133 concerning the route indicated by the route information.

The plan generation unit 23 causes the processing to proceed to Step S34 when the lane change occurs, and causes the processing to proceed to Step S37 when the lane change does not occur.

(Step S34: Start and End Points Setting Processing)

The plan generation unit 23 sets a start point 41 and an end point 42 in the range R of the lane change.

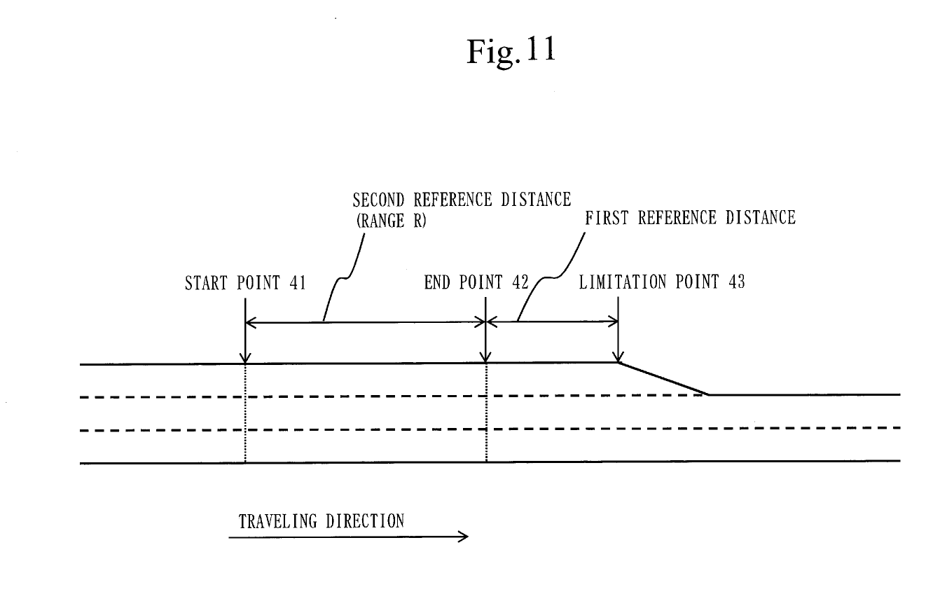

Specific explanation will be made with reference to FIG. 11. First, the plan generation unit 23 specifies a limitation point 43 of the lane change. The limitation point 43 of the lane change is a position where the lanes are reduced in a case where the lanes are reduced as shown in FIG. 11. The limitation point 43 is the final position where the vehicle can move to a branch lane when the road branches off. The limitation point 43 of the lane change is also an end point of the target section or a position of an end point in a sub-section where the lane change occurs. The limitation point 43 of the lane change is further determined in accordance with the state of the road. Next, the plan generation unit 23 sets a position moving back from the limitation point 43 by a first reference distance as the end point 42 of the lane change. Then, the plan generation unit 23 sets a position moving back from the end point 42 by a second reference distance as the start point 41 of the lane change.

A range between the end point 42 to the limitation point 43 is a range in which the lane change is performed by manual driving when the lane change is not capable of being performed by automatic driving. That is, a case where the lane change is not capable of being performed by automatic driving can occur depending on travel states of vehicles traveling around the vehicle 100 and other conditions. In this case, the driving mode is switched from automatic driving to manual driving, and the lane change is performed by manual driving. Accordingly, the first reference distance as a distance from the end point 42 to the limitation point 43 is calculated by multiplying the regulation speed in the target section by a time period necessary for switching the driving mode and the lane change by manual driving.

A range from the start point 41 to the end point 42 is the range R in which the lane change is performed by automatic driving. Accordingly, the second reference distance as a distance from the start point 41 to the end point 42 is calculated by multiplying the regulation speed in the target section by a time period necessary for the lane change by automatic driving.

The plan generation unit 23 may generate a guide plan outputting a guide for switching the driving mode to a manual driving mode and prompting the lane change in a case where the vehicle 100 travels in the lane before the lane change at the end point 42. The guide is displayed on the display device 35 or the like in accordance with the generated guide plan.

(Step S35: Curvature Determination Processing)

The plan generation unit 23 determines whether a road having a curvature lower than a reference ratio is contained between the start point 41 and the end point 42 set in Step S34 or not.

The plan generation unit 23 causes the processing to proceed to Step S36 in a case where the road having the curvature lower than the reference ratio is contained, and causes the processing to proceed to Step S37 in a case where the road having the curvature lower than the reference ratio is not contained.

(Step S36: Prohibited Section Setting Processing)

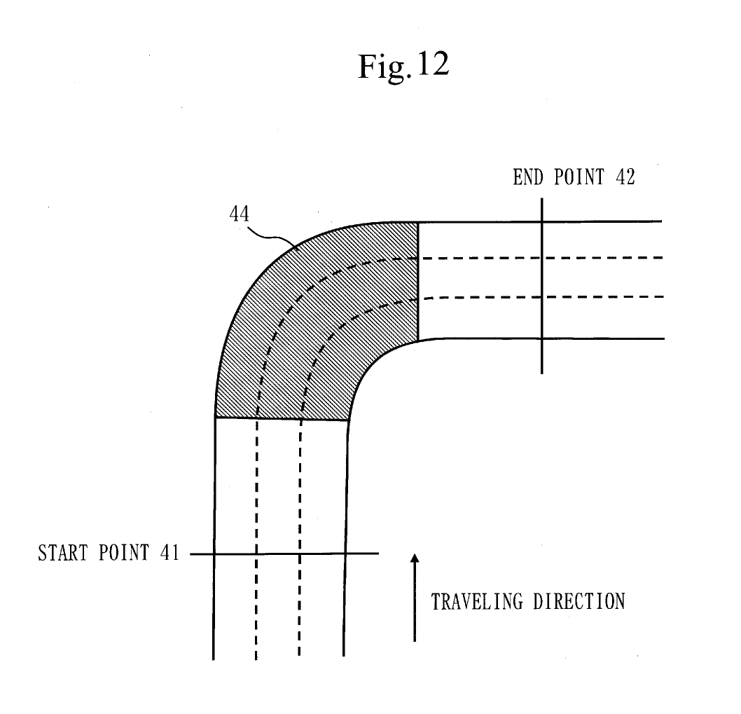

The plan generation unit 23 sets the road having the curvature lower than the reference ratio as a lane change prohibited section 44 in Step S35. That is, part of a section between the start point 41 and the end point 42 set in Step S34 is set as the lane change prohibited section 44 as shown in FIG. 12.

The plan generation unit 23 may shift the start point 41 nearer than is set in Step S34 by a distance of the lane change prohibited section 44. Accordingly, it is possible to prevent the distance of the section in which the lane change is assumed to be performed from being short and prevent the lane change from being difficult.

(Step S37: End Determination Processing)

The plan generation unit 23 determines whether all sections have been selected or not in Step S32.

In the case where all sections have been selected, the plan generation unit 23 adds the start point 41 and the end point 42 indicating the range R of the lane change set in Step S34 and the lane change prohibited section 44 set in Step S36 to the lane plan and ends the range setting processing. When an unselected section remains, the plan generation unit 23 returns the processing to Step S32.

A specific example of the range R of the lane change will be explained with reference to FIG. 8.

In FIG. 8, the lane change is performed four times, which are a lane change from the lane 4 to the lane 3, a lane change from the lane 3 to the lane 2, a lane change from the lane 2 to the lane 1 and a lane change from the lane 1 to the lane “0”. The ranges R of the lane change are set with respect to four-time lane changes respectively.

In particular, in the third section from the point P#2 to the point P#3, two-time lane changes including the lane change from the lane 3 to the lane 2 and the lane change from the lane 2 to the lane 1 are performed. In this case, the point P#3 is set as the limitation point 43 first in Step S34. Then, the end point 42 is set with respect to the lane change from the lane 2 to the lane 1 by using the limitation point 43 as a reference, and the start point 41 is set by using the end point 42 as a reference. Next, the start point 41 is set with respect to the lane change from the lane 2 to the lane 1 as the limitation point 43. Then, the end point 42 is set with respect to the lane change from the lane 3 to the lane 2 by using the limitation point 43 as a reference, and a start point 41A is set by using the end point 42 as a reference.

In this case, a road having a curvature lower than the reference ratio is contained between the start point 41A to the end point 42 relating to the lane change from the lane 3 to the lane 2. Accordingly, the road having the curvature lower than the reference ratio is set as the lane change prohibition section 44 in Step S35 to the Step S36. Then, a start point 41B is set nearer by a distance of the lane change prohibited section 44, and the range R will be from the start point 41B to the end point 42.

In FIG. 10, the plan generation unit 23 sets the start point 41 and the end point 42 when the lane change occurs. The present invention is not limited to this and the plan generation unit 23 may set the start point 41 and the end point 42 even in cases of right and left turns.

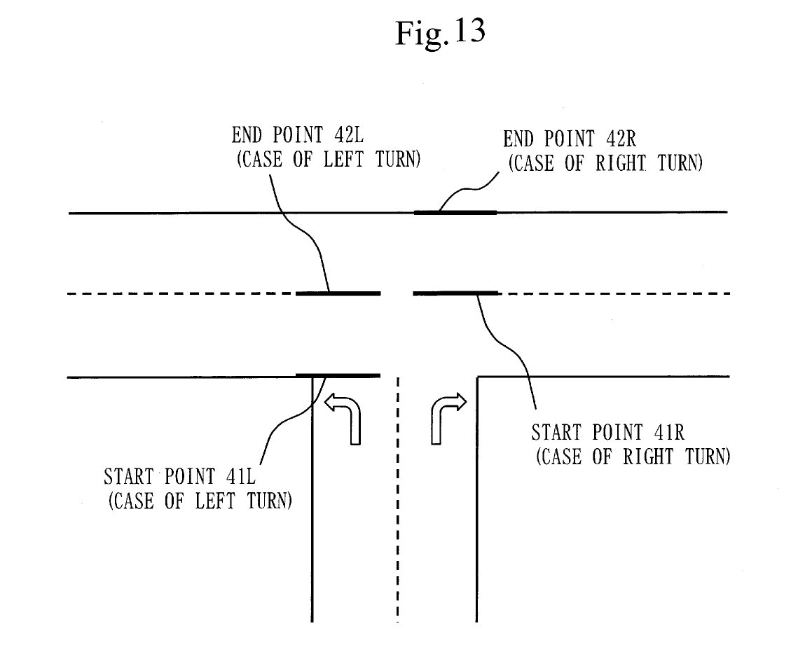

Processing for setting start points 41R, 41L and end points 42R, 42L in cases of right and left turns will be specifically explained with reference to FIG. 13. First, the plan generation unit 23 specifies the end point 42R/42L of the right/left turn. The end point 42R of right turn is a position where a component line on a far side of a lane reaching after the right turn is extended in an intersection. The end point 42L of left turn is a position where a component line on a far side of a lane after the left turn is extended in the intersection. Then, the plan generation unit 23 specifies the start point 41R/41L of the right/left turn. The start point 41R of right turn is a position where a component line on a near side of a lane reaching after the right turn is extended in the intersection. The start point 41L of left turn is a position where a component line on a near side of a lane reaching after the left turn is extended in the intersection.

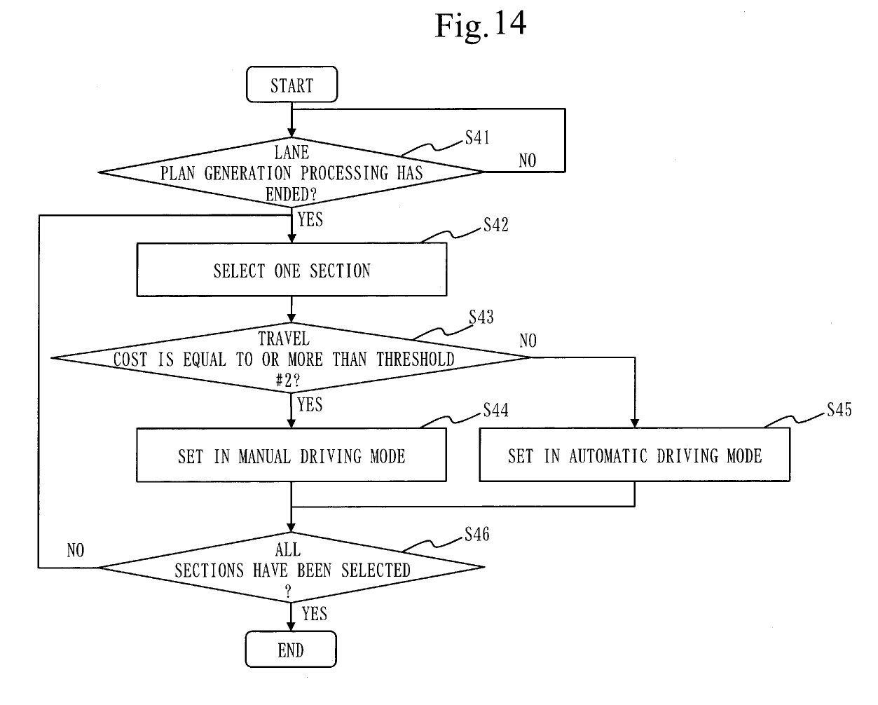

Mode plan generation processing as processing of generating the mode plan in the plan generation processing of Step S14 according to Embodiment 1 will be explained with reference to FIG. 14.

(Step S41: Start Determination Processing)

The plan generation unit 23 determines whether the lane plan generation processing has ended or not.

The plan generation unit 23 causes the processing to proceed to Step S42 in the case where the lane plan generation processing has ended, and executes Step S41 again after a certain period of time passes in the case where the lane plan generation processing has not ended.

(Step S42: Section Selection Processing)

The plan generation unit 23 selects one section from plural sections divided and generated in Step S23 as a target section.

(Step S43: Cost Determination Processing)

The plan generation unit 23 determines whether the travel cost of the section path calculated in Step S28 concerning the target section selected in Step S42 is equal to or more than a threshold #2 or not. The threshold #2 is assumed to be stored in the memory 12 before the processing shown in FIG. 14. The threshold #2 is a value higher than the threshold #1 in Embodiment 1.

The plan generation unit 23 causes the processing to proceed to Step S44 when the travel cost is equal to or more than the threshold #2, and causes the processing to proceed to Step S45 when the travel cost is less than the threshold #2.

(Step S44: Manual Mode Setting Processing)

The plan generation unit 23 sets the driving mode in the target section in the manual driving mode. That is, in a section where the travel cost is high and the automatic driving is difficult, the manual driving mode in which the vehicle 100 is driven by the driver is set.

(Step S45: Automatic Mode Setting Processing)

The plan generation unit 23 sets the driving mode in the target section in the automatic driving mode. That is, in a section where the travel cost is not high and the automatic driving is possible, the automatic driving mode in which the vehicle 100 is driven by the device such as the vehicle control ECU 31 is set.

(Step S46: End Determination Processing)

The plan generation unit 23 determines whether all sections have been selected or not in Step S42.

In the case where all sections have been selected, the plan generation unit 23 generates a mode plan indicating the driving mode set in Step S44 or Step S45 with respect to each section and ends the plan generation processing. When an unselected section remains, the plan generation unit 23 returns the processing to Step S42.

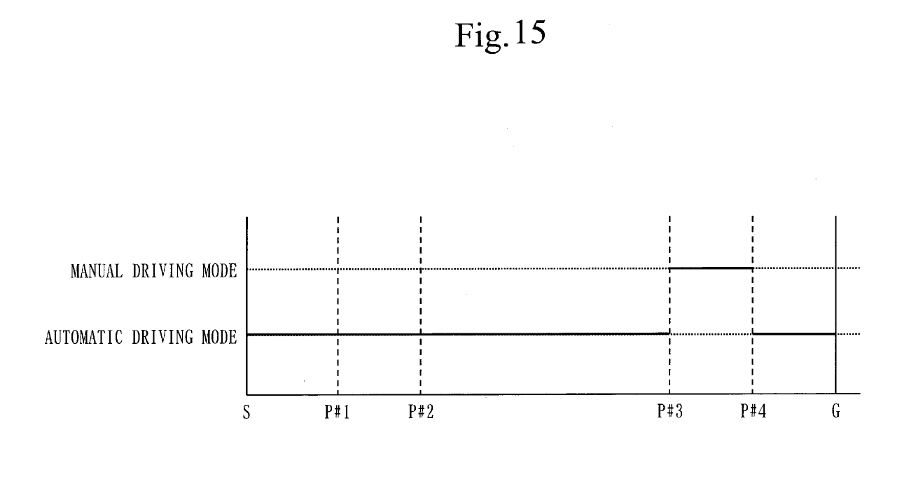

A specific example of the mode plan will be explained with reference to FIG. 8 and FIG. 15.

In Step S43, whether the travel cost is equal to or more than the threshold #2 or not is sequentially determined with respect to respective five sections. Then, the manual driving mode is set in sections in which the travel cost is equal to or more than the threshold #2 and the automatic mode is set in sections in which the travel cost is less than the threshold #2.

In FIG. 8 and FIG. 15, for example, when the travel cost in the fourth section is equal to or more than the threshold #2 and the travel costs in other sections are less than the threshold #2, the manual driving mode is set in the fourth section and the automatic driving mode is set in other sections.

After the manual driving mode is set once, the manual driving mode may be set with respect to given sections after that section, for example, all the remaining sections to the destination. That is, in FIG. 8 and FIG. 15, the manual driving mode is set in the fourth section, therefore, the manual driving mode may be set also in the subsequent fifth section.

### Advantages of Embodiment 1

As described above, the travel plan is generated based on costs corresponding to the travel state of the vehicle 100 and road environment in which the vehicle 100 travels in the travel plan generation device 10 according to Embodiment 1. Accordingly, an appropriate travel plan matching the situation can be generated. In particular, even when various types of conditions are generated redundantly, an appropriate travel plan matching respective conditions can be generated.

Also in the travel plan generation device 10 according to Embodiment 1, the travel plan is generated based on costs corresponding to the sensor configuration of the vehicle 100. Accordingly, the appropriate travel plan matching the performance of the sensor of the vehicle 100 can be generated. Additionally, it is not necessary to change the configuration of the travel plan generation device 10 even when the sensor configuration mounted on the vehicle 100 differs.

Also in the travel plan generation device 10 according to Embodiment 1, the section path not containing a sub-path in which the travel cost is equal to or more than the threshold #1 is generated. Accordingly, a section path in which control is difficult because of a lane change at a place where the additional cost is high is not generated.

### Modification Example 1

The travel plan generation device 10 includes the route search unit 21 as a functional component in Embodiment 1, and the route search unit 21 searches for the route. As a modification example 1, it is not always necessary that the travel plan generation device 10 includes the route search unit 21. In this case, the plan management unit 22 may acquire route information from the navigation device 34 through the display interface 15.

### Modification Example 2

Also in Embodiment 1, the travel plan generation device 10 includes the plan output unit 24 as a functional component and the plan output unit 24 outputs the travel plan. As a modification example 2, it is not always necessary that the travel plan generation device 10 includes the plan output unit 24. In this case, the plan management unit 22 may write the travel plan in the storage device 13 and may read the travel plan from the storage device 13 by the vehicle control ECU or the like which requires the travel plan accessing the storage device 13.

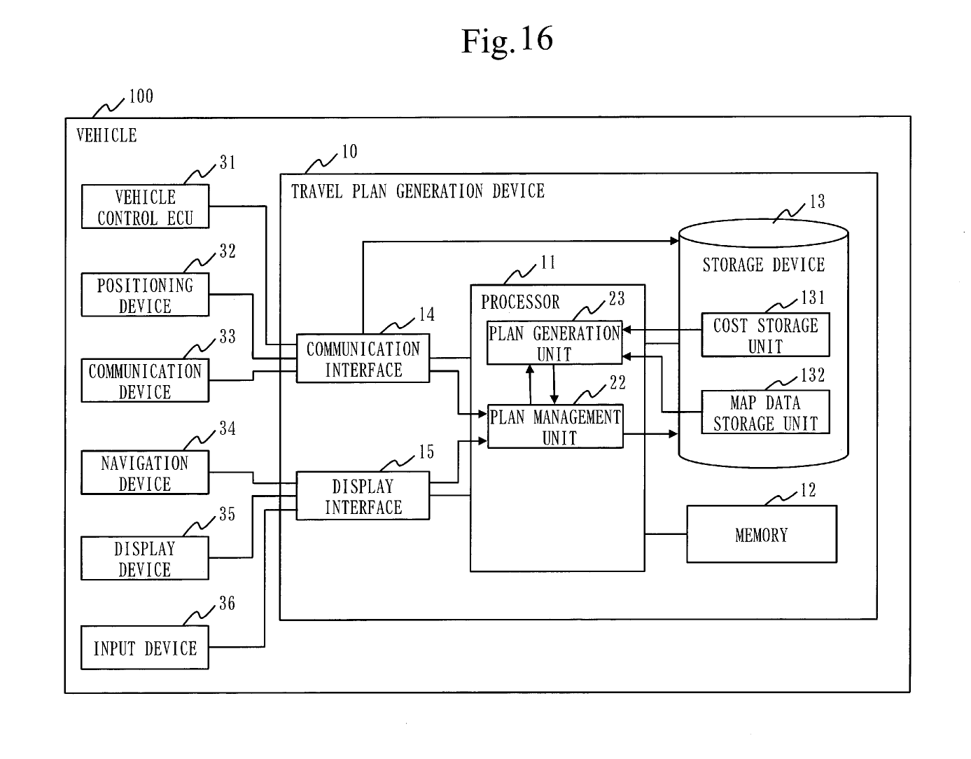

That is, the travel plan generation device 10 may have a configuration shown in FIG. 16 when considering Modification Example 1 and Modification Example 2.

The travel plan generation device 10 may include hardware such as the positioning device 32, the communication device 33, the display device 35 and the input device 36.

The device may be configured by defining a narrow-sense travel plan generation device not including part of components of the travel plan generation device 10 shown in FIG. 1 or a wide-sense travel plan generation device including components not shown in FIG. 1.

### Modification Example 3

In Embodiment 1, the travel plan generation device 10 selects the section path based on the travel cost in Step S28. As Modification Example 3, the travel plan generation device 10 may select the section path based on travel policies in addition to the travel cost. The travel policies are policies concerning travelling of the vehicle 100, which are, for example, to travel in a left lane if possible, to reduce the number of times of lane changes, to change the lane earlier and so on.

As a specific example, the travel plan generation device 10 selects the section path based on the travel cost in the same manner as Embodiment 1 so that the cost is reduced to be lower in travel states matching the travel policies and the cost is increased to be higher in travel states not matching the travel policies. Specifically, the travel plan generation device 10 selects the section path based on the travel cost in the same manner as Embodiment 1 by weighting the costs in accordance with the travel policies and the travel states.

Accordingly, the travel plan following the travel policies of the driver or the like can be generated.

### Modification Example 4

In Embodiment 1, the functions of respective units of the travel plan generation device 10 are realized by software. However, the functions of respective units of the travel plan generation device 10 may be realized by hardware as Modification Example 4. Points in Modification Example 4 different from Embodiment 1 will be explained.

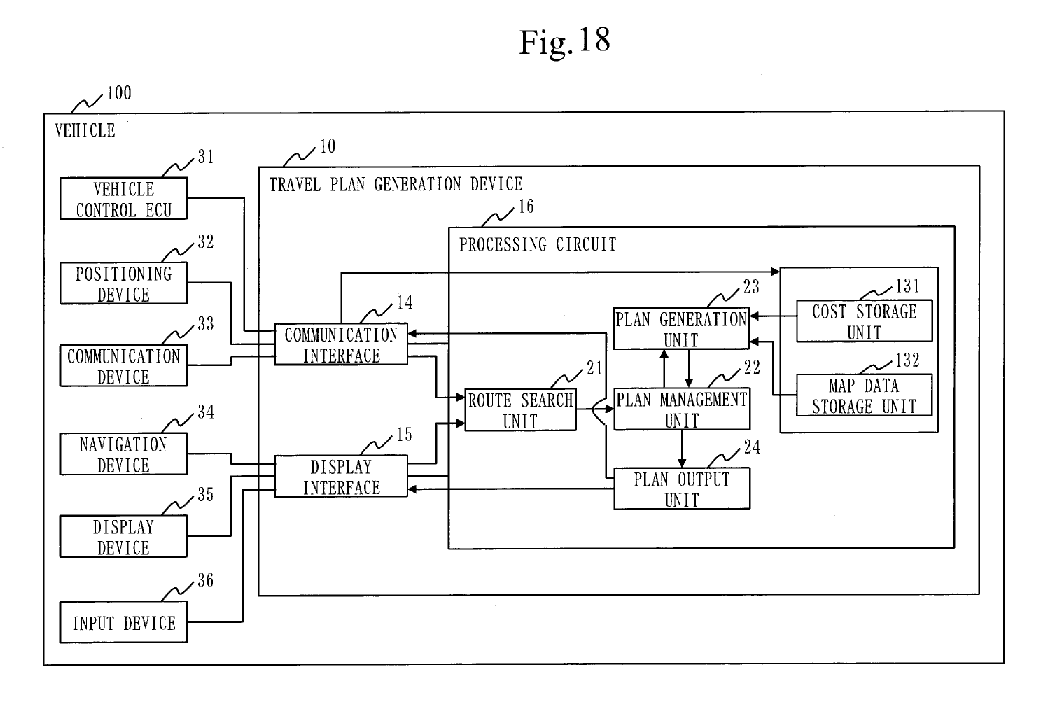

A structure of the travel plan generation device 10 according to Modification Example 4 will be explained with reference to FIG. 18.

When functions of respective units are realized by hardware, the travel plan generation device 10 includes a processing circuit 16 instead of the processor 11, the memory 12 and the storage device 13. The processing circuit 16 is a dedicated electronic circuit that realizes functions of respective units in the travel plan generation device 10, the functions of the memory 12 and the storage device 13.

As the processing circuit 16, a single circuit, a composite circuit, a programmed processor, a parallel programmed processor, a logic IC, a GA (Gate Array), an ASIC (Application Specific Integrated Circuit) and an FPGA (Field-Programmable Gate Array) are assumed to be used.

The functions of respective units can be realized by one processing circuit 16 and the functions of respective units can be realized by plural processing circuits 16 in a decentralized manner.

### Modification Example 5

As Modification Example 5, part of the functions may be realized by hardware and other functions may be realized by software. That is, it is possible that part of functions are realized by hardware and other functions are realized by software in respective units of the travel plan generation device 10.

The processor 11, the memory 12, the storage device 13 and the processing circuit 16 are collectively referred to as a “processing circuitry”. That is, the functions of respective units are realized by the processing circuitry.

Furthermore, part or all of the travel plan generation device 10 may be configured as a dedicated circuit, for example, an ECU (Electronic Control Unit).

### Embodiment 2

Embodiment 2 differs from Embodiment 1 in a point that a travel plan of a peripheral vehicle 200 travelling around the vehicle 100 is acquired and the range R of the lane change is changed based on the acquired travel plan. The different point will be explained in Embodiment 2.

***Description of Structure***

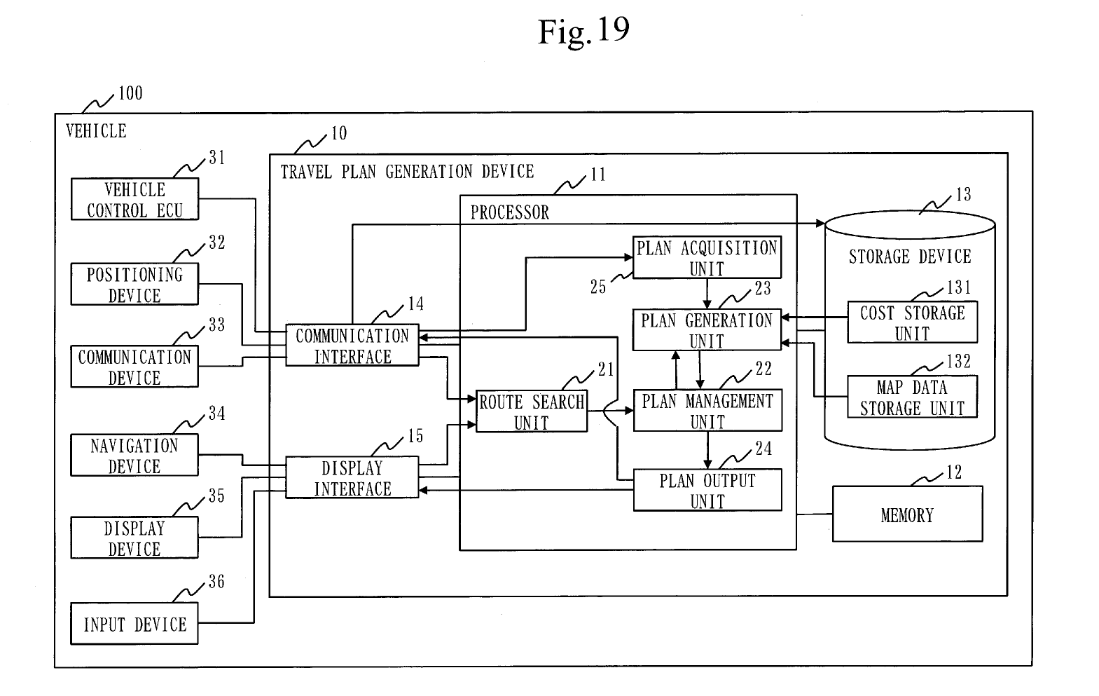

A configuration of the travel plan generation device 10 according to Embodiment 2 will be explained with reference to FIG. 19.

The travel plan generation device 10 differs from the travel plan generation device 10 shown in FIG. 1 in a point that a plan acquisition unit 25 is provided. Functions of the plan acquisition unit 25 are realized by software.

***Description of Operation***

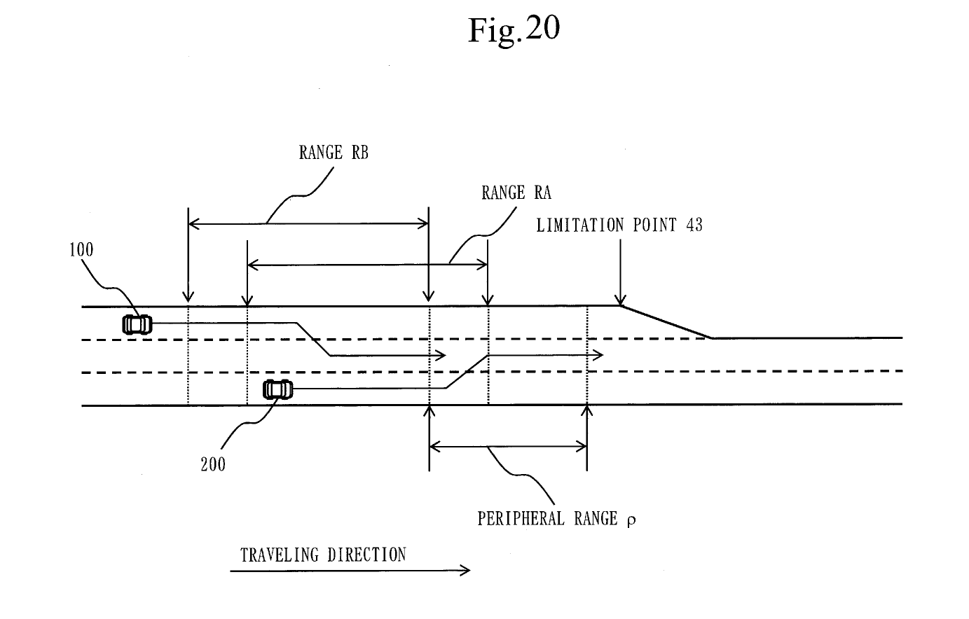

The operation of the travel plan generation device 10 according to Embodiment 2 will be explained with reference to FIG. 20.

The operation of the travel plan generation device 10 according to Embodiment 2 corresponds to a travel plan generation method according to Embodiment 2. The operation of the travel plan generation device according to Embodiment 2 corresponds to processing of a travel plan generation program according to Embodiment 2.

When the travel plan generation device 10 is activated, the plan acquisition unit 25 acquires a travel plan of the peripheral vehicle 200 through the communication device 33 and the communication interface 14 periodically or according to occurrence of events. The plan acquisition unit 25 may acquire the travel plan from the peripheral vehicle 200 directly as well as may acquire the travel plan of the peripheral vehicle 200 from devices such as a roadside unit.

The plan acquisition unit 25 writes the acquired travel plan in the memory 12 and deletes the travel plan from the memory 12 after a certain period of time passes.

When Step S34 of FIG. 10 is executed during traveling of the vehicle 100, the plan generation unit 23 reads the travel plan acquired by the plan acquisition unit 25 from the memory 12. Then, the plan generation unit 23 sets the start point 41 and the end point 42 in the range R of the lane change by referring to the read travel plan.

A specific example will be explained with reference to FIG. 20. First, the plan generation unit 23 sets a range RA as the range R of the lane change by the same procedure as Embodiment 1. Next, the plan generation unit 23 determines whether a peripheral range p as a range in which the peripheral vehicle 200 performs the lane change as indicated by the travel plan of the peripheral vehicle 200 overlaps with the range RA or not. When the peripheral range p overlaps with the range RA, the plan generation unit 23 shifts the range RA nearer until the range RA does not overlap with the peripheral range p to set the range as a new range RB. The plan generation unit 23 may shift the range RA farther until the range RA does not overlap with the peripheral range ρ to set the range as the new range RB depending on an overlapping state.

The plan generation unit 23 may set the range R so as to include at least part of a range not overlapping with the peripheral range p without setting the range R so as not to overlap with the peripheral range p at all.

### Advantages of Embodiment 2

As described above, the travel plan generation device 10 according to Embodiment 2 sets the range R of the lane change of the vehicle 100 so that the range R does not overlap with the peripheral range p in which the lane change indicated by the travel plan of the peripheral vehicle 200 is performed. Accordingly, the travel plan in which the lane change can be performed without being affected by the peripheral vehicle 200 can be generated. As a result, the entire traffic flows smoothly.

### Other Configurations

In Embodiment 2, the range R of the lane change of the vehicle 100 is set so that the range R does not overlap with the peripheral range p in Step S34 of FIG. 10. As Modification Example 6, the peripheral range p is regarded as part of the dynamic map data 134 and the cost may be set to be higher with respect to the lane change in the peripheral range ρ.

In this case, the target section is divided into sub-sections in front of and behind the peripheral range p in Step S25 of FIG. 5. Then, when the section path is selected in Step S28 of FIG. 5, the possibility that the section path not containing the sub-path is selected is increased as the cost in the sub-path in which the lane is changed in the peripheral range p is higher. As a result, the possibility that the peripheral range ρ does not overlap the range R is increased.

The travel cost in the sub-path in which the lane is changed in the peripheral range ρ in Step S27 is equal to or more than the threshold #1 according to the situation of other dynamic map data 134 or the like, and the sub-path may be excluded from selection targets.

### Modification Example 7

In Embodiment 2, the travel plan generation device 10 acquires and uses the travel plan of the peripheral vehicle 200. As Modification Example 7, the travel plan generation device 10 may output the travel plan of the vehicle 100 toward the peripheral vehicle 200.

Accordingly, it is preferable that the peripheral vehicle 200 is made to change the peripheral range ρ so as not to overlap with the range R of the lane change.

### Modification Example 8

In Embodiment 2, the travel plan generation device 10 sets the range R of the lane change so as not to overlap with the peripheral range p. As Modification Example 8, a traveling position of the vehicle 100 in the travelling direction may be shifted from a traveling position of the peripheral vehicle 200 in the traveling direction by adjusting the speed of the vehicle 100. That is, the travel plan generation device 10 may change a speed plan in the travel plan, not changing the range R of the lane change.

Accordingly, the lane change can be performed without being affected by the peripheral vehicle 200 even when the range R of the lane change overlaps with the peripheral range ρ.

### Modification Example 9

In Embodiment 2, the travel plan generation device 10 sets the range R of the lane change. As Modification Example 9, another device such as a roadside unit may acquire travel plans of the vehicle 100 and the peripheral vehicle 200 and another device may set the range R of the vehicle 100 and the peripheral range ρ of the peripheral vehicle 200.

The embodiments and modification examples of the present invention have been explained above. Some of these embodiments and modification examples may be combined to be achieved. Also, any one or some of these embodiments and the modification examples may be partially achieved. The present invention is not limited to the above embodiments and modification examples, and various alternations may occur according to need.

### REFERENCE SIGNS LIST

10: travel plan generation device
11: processor
12: memory
13: storage device
14: communication interface
15: display interface
16: processing circuit
21: route search unit
22: plan management unit
23: plan generation unit
24: plan output unit
25: plan acquisition unit
31: vehicle control ECU
32: positioning device
33: communication device
34: navigation device
35: display device
36: input device
41: start point
42: end point
43: limitation point
44: lane change prohibited section
100: vehicle

1-12. (canceled)

13. A travel plan generation device comprising:
processing circuitry
to output route information indicating a route from a reference position to a destination, and
to determine a lane plan indicating lanes in which a vehicle travels in respective sections forming the route indicated by the route information output and a mode plan indicating in which mode of automatic driving and manual driving the vehicle is controlled in the respective sections based on costs corresponding to a travel state of the vehicle and road environment in which the vehicle travels, and generate a travel plan including the determined lane plan and the determined mode plan.

14. The travel plan generation device according to claim 13,
wherein the travel state includes a lane in which the vehicle travels and a behavior of the vehicle.

15. The travel plan generation device according to claim 14,
wherein the behavior is a behavior of the vehicle that indicates a direction of a lane change of the vehicle.

16. The travel plan generation device according to claim 13,
wherein the road environment includes an attribute of a road in which the vehicle travels and dynamic conditions indicating a situation of the road that dynamically changes.

17. The travel plan generation device according to claim 16,
wherein the sections are sections that are divided to correspond to target ranges of the dynamic conditions.

18. The travel plan generation device according to claim 16,
wherein the cost is a sum of a basic cost corresponding to the travel state and the attribute and an additional cost corresponding to the travel state and the dynamic conditions.

19. The travel plan generation device according to claim 13,
wherein the processing circuitry generates the mode plan indicating that the vehicle is controlled by the manual driving in a section in which the cost exceeds a threshold in the route.

20. The travel plan generation device according to claim 13,
wherein the cost further includes a cost corresponding to a sensor configuration possessed by the vehicle.

21. The travel plan generation device according to claim 13,
wherein the processing circuitry sets a range in which a lane change is performed when a lane plan indicating that the lane in which the vehicle travels is changed is generated.

22. The travel plan generation device according to claim 21,
wherein the processing circuitry generates a guide plan to output a guidance to prompt a driver to change the lane by manual driving by using an end point of the range in which the lane change is performed as a starting point.

23. The travel plan generation device according to claim 21, wherein the processing circuitry
acquires range information indicating a peripheral range in which a peripheral vehicle existing on a periphery of the vehicle performs a lane change, and
sets a range in which the lane change is performed so as to include a range not overlapping with the peripheral range indicated by the range information acquired.

24. A travel plan generation method executed by a travel plan generation device, the travel plan generation method comprising:
outputting route information indicating a route from a reference position to a destination; and
determining a lane plan indicating lanes in which a vehicle travels in respective sections forming the route indicated by the output route information and a mode plan indicating in which mode of automatic driving and manual driving the vehicle is controlled in the respective sections based on costs corresponding to a travel state of the vehicle and road environment in which the vehicle travels, and generating a travel plan including the determined lane plan and the determined mode plan.

25. A non-transitory computer readable recording medium storing a travel plan generation program allowing a computer to execute:
plan management processing to output route information indicating a route from a reference position to a destination, to a memory; and
plan generation processing to determine a lane plan indicating lanes in which a vehicle travels in respective sections forming the route indicated by the route information output to the memory by the plan management processing and a mode plan indicating in which mode of automatic driving and manual driving the vehicle is controlled in the respective sections based on costs corresponding to a travel state of the vehicle and road environment in which the vehicle travels, generate a travel plan including the determined lane plan and the determined mode plan, and output the generated lane plan and the generated mode plan to the memory.
